(19) United States
(12) Patent Application Publication
(10) Pub. No.: US 2011/0127334 A1
(43) Pub. Date: Jun. 2, 2011

(54) MEM AUTO-FOCUSING SYSTEM

(75) Inventors: David Tsi Shi, Stony Brook, NY (US); Christopher Brock, Manorville, NY (US)

(73) Assignee: Symbol Technologies, Inc., Holtsville, NY (US)

(21) Appl. No.: 12/627,166

(22) Filed: Nov. 30, 2009

(51) Int. Cl. G06K 7/10

(52) U.S. Cl. 235/462.35; 235/454

(57) ABSTRACT

A method (100) and laser scanning system (10) for reading indicia (18) comprises a laser diode (60) that projects a light beam (LB) along an optical axis of the laser scanning system toward target indicia and a photodetector (34) that receives light reflected from the target indicia during operation of the laser scanning system. The system further comprises an auto-focusing arrangement (64) having a micro-electromechanical device (68) moveably coupled to a focusing lens (66) such that activation of the micro-electromechanical device provides controlled movement of the focusing lens along the optical axis relative to the laser scanning system, altering the profile of the light beam projected from the laser diode upon the target indicia.

### TECHNICAL FIELD

The present disclosure relates to a laser barcode scanning system, and more particularly, a laser barcode scanning system having an extended working range and enhanced focus quality that includes a MEM auto-focusing lens assembly.

### BACKGROUND

Using a laser reader or scanner for reading a barcode, that is, decoding the encoded indicia of a target barcode represented by elements of the barcode is well known. The laser scanner generates a beam of light, typically a laser beam, which is repeatedly scanned across a target barcode. The elements or features of a barcode, e.g., black bars and white spaces of, for example, a UPC barcode, absorb and diffusely reflect the laser beam light. Reflected light from the barcode is collected and focused on one or more photodetectors of the laser scanner. Output signals from the one or more photodetectors are appropriately processed and subsequently input to decoding circuitry of the scanner and decoded.

A laser barcode reader or scanner containing a fixed-focus lens assembly typically requires several special optical arrangements (e.g., lorax, soft-focus etc.). The fixed-focus lens assembly has been developed to obtain a substantially constant (less diverging) laser spot size over a semi-extended range. However, such designs usually require expensive and high precision optics to achieve such quality. In addition, such fixed-focus lens assemblies (described above) generally require complex electronic signal processing capabilities to handle a low optical modulation transfer function (“MTF”) from the laser beam profile.

### SUMMARY

One example embodiment of the present disclosure includes a laser scanning system for reading indicia comprising a laser diode that projects a light beam along an optical axis of the laser scanning system toward target indicia and a photodetector that receives light reflected from the target indicia during operation of the laser scanning system. The system further comprises an auto-focusing arrangement having a micro-electromechanical device moveably coupled to a focusing lens such that activation of the micro-electromechanical device provides controlled movement of the focusing lens along the optical axis relative to the laser scanning system, altering the profile of the light beam projected from the laser diode upon the target indicia.

Another example embodiment of the present disclosure includes a method for altering a light beam projected from a laser scanning system for reading indicia. The method comprises projecting a light beam at target indicia with a laser diode to define an optical axis of the laser scanning system and receiving reflected light from the target indicia during operation of the laser scanning system with a photodetector. The method further comprises focusing the light beam in the laser scanning system projected by the laser diode with a micro-electromechanical device moveably coupled to a focusing lens and actuating the micro-electromechanical device such that controlled movement occurs in the focusing lens along the optical axis relative to the laser scanning system, altering the profile of the light beam projected from the laser diode upon the target indicia.

Yet another example embodiment of the present disclosure includes a laser scanning system for reading indicia. The laser scanning system comprises a laser diode fixedly attached to a scanning arrangement positioned within the laser scanning system that provides a light beam about an optical axis of the laser scanning system toward target indicia during operation and a photodetector coupled with the scanning arrangement that receives light reflected from the target indicia during operation of the laser scanning system. The system also comprises an auto-focusing assembly comprising a micro-electromechanical device and a focusing lens movably connected to the micro-electromechanical device, the micro-electromechanical device is positioned between the laser diode and the focusing lens along the optical axis of the laser scanning system. The system also includes controller that provides a select amount of power to the micro-electromechanical device that enables a controlled movement of the focusing lens along the optical axis relative to the laser scanning system, altering the profile of the light beam projected from the laser diode upon the target indicia.

These and other objects, advantages, and features of exemplary embodiments are described in detail in conjunction with the accompanying drawings.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a laser scanning system in the form of a hand-held scanner constructed in accordance to one example embodiment of the present disclosure;

FIG. 2 illustrates schematically an electro-optical arrangement representative of the laser scanning system constructed in accordance with one example embodiment of the present disclosure;

FIG. 3 illustrates a laser scanning system projecting a laser or light beam in accordance with one example embodiment of the present disclosure;

FIG. 4 illustrates an auto-focus lens assembly comprising a MEM device receiving a focusing lens in accordance with one example embodiment of the present disclosure;

FIG. 5A Illustrates a laser beam profile projected from the laser scanning system under a first lens focus position;

FIG. 5B Illustrates a laser beam profile projected from the laser scanning system under a second lens focus position; and

FIG. 6 illustrates a method of altering a light beam projected from a laser scanning system in accordance with one example embodiment of the present disclosure.

### DETAILED DESCRIPTION

The present disclosure relates to a laser barcode scanning system 10, and more particularly, a laser barcode scanning system having an extended working range and enhanced focus quality that includes a micro-electromechanical (“MEM”) auto-focusing lens assembly. The laser barcode scanning system 10 further comprises a laser focusing operation that includes the MEM auto-focus lens assembly, which reduces the complexity associated with a fixed-focus lens, while achieving a high modulation transfer function (“MTF”) value. The laser barcode scanning system 10 of the present disclosure in addition to obtaining a high MTF value, includes a large focus aperture that generates high output power through-put. The disclosed laser focusing operation and its large focus aperture and variable focus positions provide the laser barcode scanning system 10 with the ability not only to read a medium or low density barcode at a far distance, but also it can read a high density barcode at a close distance. Stated another way, the laser barcode scanning system 10 of the present disclosure eliminates the requirements of an expensive and complex optical lens assembly by using the MEM auto-focusing lens assembly in combination with the laser focusing operation. The MEM auto-focusing lens assembly in combination with the laser focusing operation collectively achieves scanning objectives required by several individual scanning devices (that include high density (“HD”), standard (“STD”), and long range (“LR”)) uniquely into a single system.

In addition, the disclosed MEM auto-focusing lens assembly in combination with the laser focusing operation provides a higher scan quality level compared to fixed-focus lens and other auto-focus mechanisms (such as voice coil and piezo), and the disclosed laser focusing arrangement is reliable, easier, and less costly to assemble, and provides enhanced precision control over the known auto-focusing mechanisms identified above.

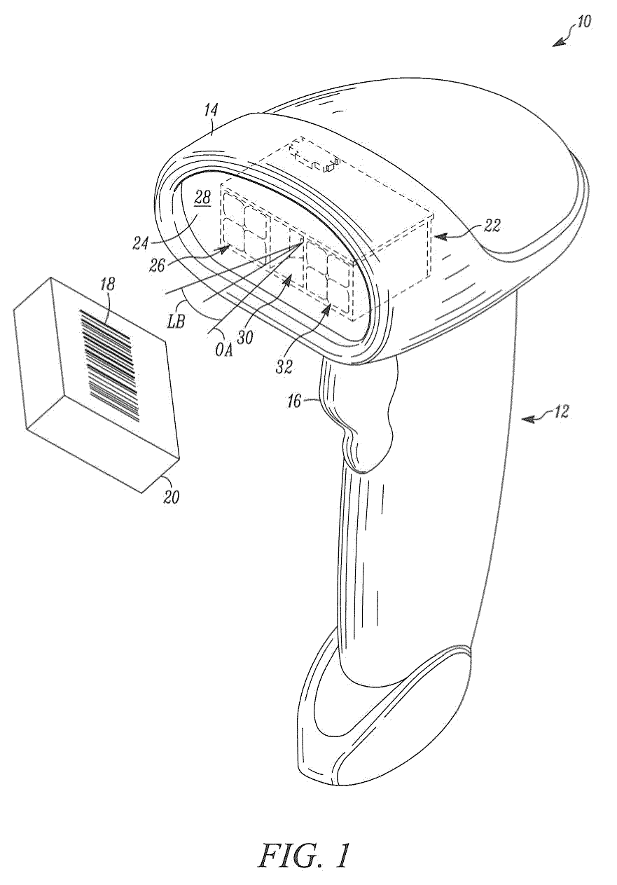

Referring now to the figures and in particular, to FIG. 1 is a laser scanning system 10 in the form of a hand-held scanner 12 constructed in accordance to one example embodiment of the present disclosure. The scanner 10 is supported in a pistol-shaped housing 14 that can be carried and used by a user walking or riding through a store, warehouse, or plant for reading barcodes for stocking and inventory control purposes. In an alternative example embodiment, the laser scanning system 10 is incorporated into a swipe or presentation-type scanner. It is the intent of the present disclosure to encompass all such scanners.

The laser scanning system 10 of the present disclosure is used to scan and decode barcodes, such as, 1D barcodes, postal codes, and the like. As used herein, the term “barcode” is intended to be broadly construed to cover not only barcode symbol patterns comprised of alternating bars and spaces, but also other graphic patterns, such as dot or matrix array patterns and, more generally, indicia having portions of different light reflectivity or surface characteristics that result in contrasting detected signal characteristics that can be used for encoding information and can be scanned and decoded using the scanning system 10.

The hand-held scanner 12 includes an actuation trigger 16 for enabling the scanning system 10 to scan and decode a target barcode 18 typically affixed to a target object 20. Located within the housing 14 of the hand-held scanner 12 is a scanning module 22. The scanning module 22 is, in turn supported, within a front or forward facing portion 24 (FIG. 1) of the scanner housing 14. A scanning end 26 of the scanning module 22 (this is, the end of the scanning module 22 facing the target barcode 18) is positioned adjacent to and behind a protective transparent window 28. The transparent window 28 is enclosed within the housing 14.

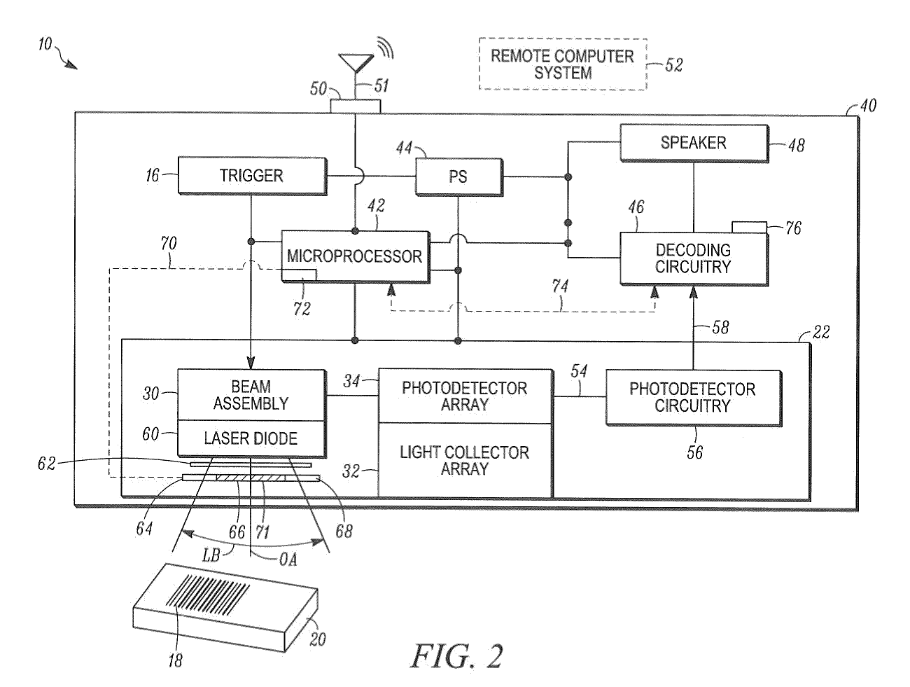

The scanning module 22 includes a beam assembly 30 for producing a scanning light beam about an optical axis (“OA”) as best seen in FIGS. 1 and 2. An array of non-imaging light collectors 32 receive and concentrate reflected light from the target barcode 18 upon a corresponding array of photodetectors 34 (see FIG. 2). In an alternative example embodiment, reflected light from the target barcode 18 is received directly on photodetectors 34 without the aid of collectors 32.

FIG. 2 illustrates schematically an electro-optical arrangement 40 representative of the laser scanning system 10 constructed in accordance with one example embodiment of the present disclosure. In particular, the electro-optical arrangement 40 includes in addition to the scanning module or scan engine 22, a microprocessor 42, power supply 44, decoding circuitry 46, speaker 48, and data communications ports 50. The power supply 44 provides regulated DC power to the various electrical components within the electro-optical arrangement 40.

The microprocessor 42 is powered by the power supply 44 and coupled to the scan engine 22, trigger 16, decoding circuitry 46, and data communications ports 50 through, for example, various I/O pins of the microprocessor. The speaker 48 provides an audio output to a user of the scanner 10 upon successful reading, that is, scanning and decoding of the target barcode 18. The data communications ports 50 include an RF transceiver 51 for receiving and transmitting data for uploading and downloading information to and from a remote computer system 52.

The photodiodes 34 receive light reflected from the target barcode 18 and convert the reflected light to an analog signal 54 representative of the pattern of dark bars and light spaces of the barcode 18. The analog signal's output from the photodiodes 34 are received by an input to photodetector circuitry 56 where the signals are appropriately sampled, selected and/or combined to generate a robust output signal 58 with a good signal to noise ratio. The output signal 58 is then digitized. The digitized output signal 58 is subsequently decoded by decoding circuitry 46, which is in communication with the microprocessor 42.

The beam assembly 30 of the scanning module 22 produces a light beam “LB” such as a laser beam that is scanned repetitively to generate a scan line about an optical axis OA. The beam assembly 30 includes a laser diode 60, a mirror assembly 62 comprising a fold mirror and an oscillating mirror.

The laser diode 60 generates the laser light beam LB that is directed to intersect the fold mirror then the oscillating mirror of the mirror assembly 62. The oscillating mirror in the mirror assembly 62 oscillates via a drive mechanism (not shown) about a vertical axis transverse to the optical axis through an arc or scanning rotation angle. The light beam LB is thereby reflected, redirected, and scanned in a horizontal direction by the oscillating mirror. The redirected scanning light beam LB reflected by the mirror assembly 62 is directed through an auto-focusing lens assembly 64 that comprises a focusing lens 66 and micro-electromechanical MEM device 68 moveably connected to the focusing lens as best seen in FIGS. 2-4. In one example embodiment, a suitable MEM device 68 includes a MEM manufactured by Siimpel of Arcadia, Calif. under part number SF23XS. The data and specification sheets for the Siimpel SF23XS MEM are incorporated herein by reference.

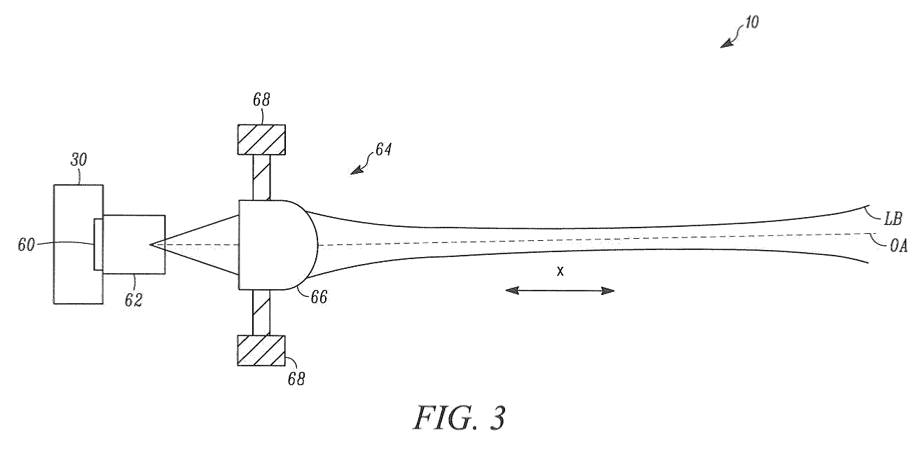

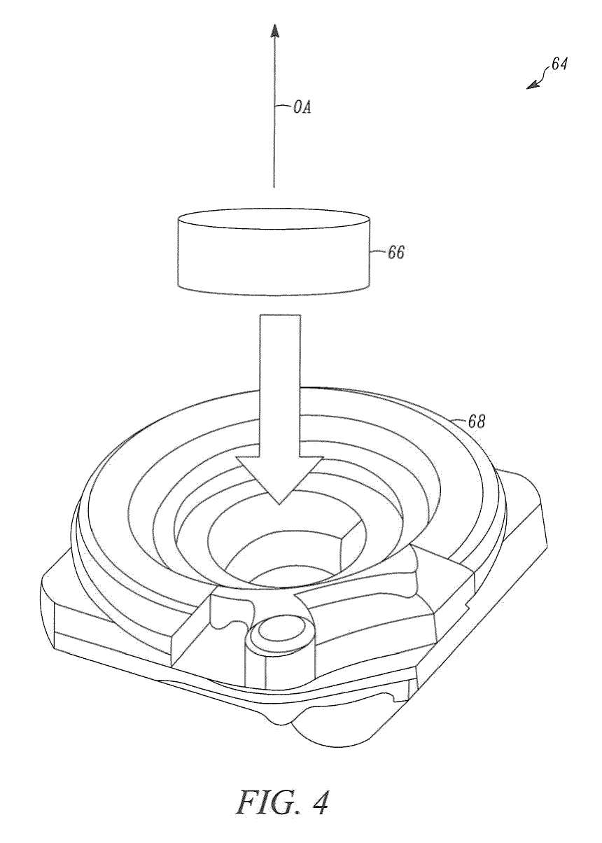

The focusing lens 66 in one example embodiment is a singlet lens. In another example embodiment, the focusing lens 66 is a plastic aspherical lens. The focusing lens 66 is inserted into the MEM device 68 as best seen in FIG. 4. The focusing lens 66 is actuated along the optical-mechanical or optical axis OA in the direction of Arrows X in FIG. 3 by the MEM device 68 with precise position control of the microprocessor 42 in approximate incremental distances of one micron. As further illustrated in FIG. 3, the MEM device 68 and focusing lens 66 are positioned in front of the laser diode 60 and out-going laser beam LB. The system 10 can be focused differently as the focusing lens 66 is moved back and forth along the optical axis OA by the MEM device 68 through electronic voltage control provided by an output of the microprocessor 42.

In an alternative example embodiment, the focusing lens 66 is actuated by the MEM device 68 in a direction transverse to the optical axis OA. In yet another example embodiment, the focusing lens 66 is actuated longitudinally along the optical axis OA and transverse to the optical axis OA by a compound MEM device 68, comprising a MEM with two axes of movement or a compound MEM comprising two MEMs piggybacked, each MEM having a respective one axis of movement.

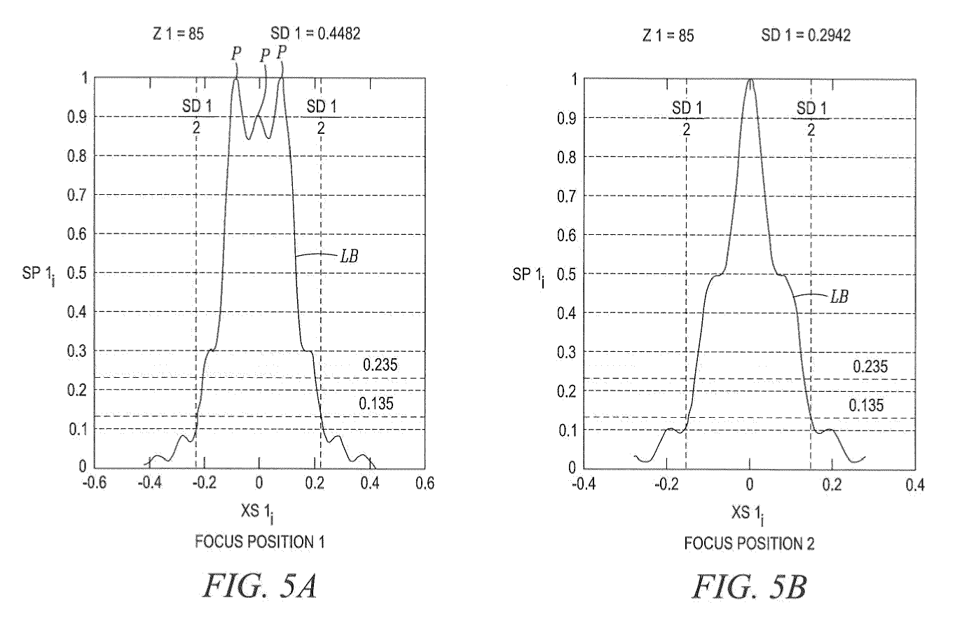

Illustrated in FIGS. 5A and 5B are laser beam LB profiles projected from the laser scanning system 10 under different lens focus positions. In focus position 1, illustrated in FIG. 5A, there are multiple peaks (“P”) on the laser beam profile LB, which is harmful to the signal processing and barcode reading because it creates false edges for the digital barcode pattern received by the photodetectors 34. Advantageously through the auto-focusing lens assembly 64 of the present disclosure, the focusing lens 66 is actuated by the MEM device 68 to focus position 2, illustrated in FIG. 5B. In focusing position 2 of FIG. 5B, the focusing lens 66 was moved by the MEM device 68 by 40 μm (micrometers) away from the laser diode 60 about the optical axis OA. The laser beam LB profile illustrated in FIG. 5B, provides a smooth shape and its related MTF value when compared to position 1 of FIG. 5A is very high, advantageously allowing the resolution and decoding of high density barcodes over an extended range.

The auto-focusing lens assembly 64 further comprises a laser focusing operation 70 coupled with the microprocessor 42 of the laser scanning system 10. Unlike a fixed-focus laser that is focused at the time of manufacture using a fixture, the laser scanning system 10 of the present disclosure is capable of focusing the lens during operation of the scanning system via the laser focusing operation 70 in combination with the auto-focusing lens assembly 64. The laser focusing operation 70 employs various heuristic techniques by the microprocessor 42 that results in the moving the focusing lens 66 with the MEM device 68.

In one example embodiment, the laser focusing operation 70 involves the microprocessor 42 cycling the focusing lens 66 via the MEM device 68 through a number of different pre-computed focus positions and the decoding circuitry 46 attempts to decode the output signal 58 from the photodetector circuitry for each focus position. A focusing position 71 for the focusing lens 66 along the optical axis OA would then be chosen from the pre-computed focus positions programmed in the microprocessor 42, such that the focusing position 71 provided a high enough MTF such that the working range of the laser scanning system was continuous. Stated another way, the chosen focusing position 71 allows the scanner 10 to successfully scan high density through long range target barcodes 18 independent of their proximity to the laser scanning system. This laser focusing operation 70 and the calculated focusing position 71 establishes a reference focus lens 66 location at the time of manufacture and storing that focusing position in memory of the microprocessor 42, advantageously reduces the number of focus positions needed for full working range coverage.

In another example embodiment, the laser focusing operation 70 comprises using a feedback loop 74 that allows the microprocessor 42 to use a waveform decoder 76 (see FIG. 2) to evaluate at the microprocessor, the sharpness scores from the return laser data or reflected laser light received by the photodetectors 34. This laser focusing operation 70, presupposes that the laser scanning system 10 is covering the same target barcode 18 on multiple passes. Further confirmation could be achieved in the laser focusing operation 70 by aligning edges of patterns, matching the patterns from different scans to reassure that consecutive sharpness scores were valid among scans.

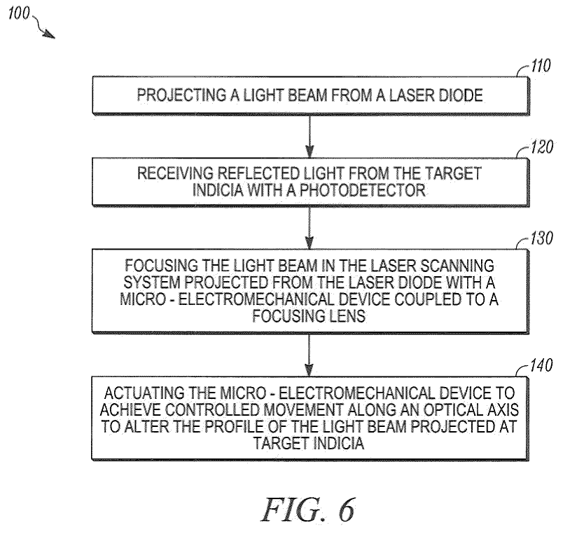

FIG. 6 is a method 100 of altering a light beam projected from a laser scanning system in accordance with one example embodiment of the present disclosure. At 110, the method 100 comprises projecting a light beam from a laser diode. At 120, the method 100 comprises receiving reflected light from the target indicia during operation of the laser scanning system with a photodetector. At 130, the method 100 comprises focusing the light beam in the laser scanning system projected by the laser diode with a micro-electromechanical device moveably coupled to a focusing lens. At 140, the method 100 comprises actuating the micro-electromechanical device to achieve controlled movement along an optical axis to alter the profile of the light beam projected at target indicia.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A laser scanning system for reading indicia, the laser scanning system comprising:
a laser diode that provides a light beam along an optical axis of the laser scanning system toward target indicia during operation;
a photodetector that receives light reflected from the target indicia during operation of the laser scanning system; and
an auto-focusing arrangement comprising a micro-electromechanical device moveably coupled to a focusing lens such that activation of the micro-electromechanical device provides controlled movement of the focusing lens along said optical axis relative to said laser scanning system, altering the profile of said light beam projected from said laser diode upon said target indicia.

2. The system of claim 1 further comprising a controller for providing a select amount of voltage to said micro-electromechanical device that results in a prescribed positioning of said focusing lens during operation.

3. The system of claim 2 wherein said controller selectively provides said select amount of voltage to said micro-electromechanical device by a heuristic technique.

4. The system of claim 3 wherein said controller heuristic technique includes evaluating reflected light received by said photodetector for an optimum signal based on the movement of said focusing lens with said micro-electromechanical device through a plurality of pre-computed focusing lens positioned programmed in said controller.

5. The system of claim 3 wherein said controller heuristic technique includes evaluating reflected light received by said photodetector for an optimum signal using a waveform decoder based on the movement of said focusing lens with said micro-electromechanical device.

6. The system of claim 1 wherein said focusing lens is an aspherical lens.

7. A method for altering a light beam projected from a laser scanning system for reading indicia, the method comprising the steps of:
projecting a light beam at target indicia with a laser diode to define an optical axis of the laser scanning system;
receiving reflected light from the target indicia during operation of the laser scanning system with a photodetector;
focusing said light beam in the laser scanning system projected by said laser diode with a micro-electromechanical device moveably coupled to a focusing lens; and
actuating said micro-electromechanical device such that controlled movement occurs in said focusing lens along said optical axis relative to said laser scanning system, altering the profile of said light beam projected from said laser diode upon said target indicia.

8. The method of claim 7 further comprising positioning said micro-electromechanical device between said laser diode and said focusing lens.

9. The method of claim 7 further comprising actuating said micro-electromechanical device with a controller coupled to said laser scanning system.

10. The method of claim 9 wherein said controller is remotely coupled to said laser scanning system.

11. A laser scanning system for reading indicia, the laser scanning system comprising:
a laser diode fixedly attached to a scanning arrangement positioned within said laser scanning system that provides a light beam about an optical axis of the laser scanning system toward target indicia during operation;
a photodetector coupled with said scanning arrangement that receives light reflected from the target indicia during operation of the laser scanning system;
an auto-focusing assembly comprising a micro-electromechanical device and a focusing lens moveably connected to said micro-electromechanical device, the micro-electromechanical device being positioned between said laser diode and said focusing lens along the optical axis of said laser scanning system; and
a controller that provides a select amount of power to said micro-electromechanical device that enables controlled movement of said focusing lens along said optical axis relative to said laser scanning system, altering the profile of said light beam projected from said laser diode upon said target indicia.

12. The system of claim 11 wherein said focusing lens is an aspherical lens.

13. The system of claim 11 wherein said controller selectively provides said select amount of voltage to said micro-electromechanical device by a heuristic technique.

14. The system of claim 13 wherein said controller heuristic technique includes evaluating reflected light received by said photodetector for an optimum signal based on the movement of said lens with said micro-electromechanical device through a plurality of pre-computed lens positions programmed in said controller.

15. The system of claim 13 wherein said controller heuristic technique includes evaluating reflected light received by said photodetector for an optimum signal using a waveform decoder based on the movement of said lens with said micro-electromechanical device.
